(19) United States
(12) Patent Application Publication
(10) Pub. No.: US 2006/0093344 A1
(43) Pub. Date: May 4, 2006

(54) Ring flash for camera

(75) Inventor: John C. Neel, Pittsford, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/979,034

(22) Filed: Nov. 1, 2004

(51) Int. Cl. G03B 15/03

(52) U.S. Cl. 396/176

(57) ABSTRACT

A camera, such as a digital camera, or a video camera, with a flash and/or a light source and further having a lens with an imaging axis includes a light transferring device, and a flash dispersion structure disposed around the imaging axis of the lens. The flash is located on the housing of the camera and provides light via a flash to the light-transferring device. The light-transferring device directs the light from the flash to the flash dispersion structure. The flash dispersion structure directs the light onto an object of interest.

### FIELD OF THE INVENTION

The present embodiments relate to cameras that utilize a ring flash to create a very soft shadow or shadow less type lighting that is optimum for most macro photography.

### BACKGROUND OF THE INVENTION

Current built in flash units create a type of flash that causes a very harsh lighting effect. The harsh lighting effect creates a difficult lighting solution for some applications, such as medical lighting. In the past medical lighting has relied on a type of flash that encircles the lens. Using a flash that encircles the lens creates a very soft shadow or shadow less type. This type of lighting is an easy light for use in dental procedures and in surgery because the lens is close and allows the practitioner to place the light inside the body cavity being photographed. Using a flash that encircles the lens provides the type of lighting needed for most macro work, such a dental photography, surgical photography, and close-up nature work.

The problem with using a flash that encircles the lens is that the current systems are difficult to use since the current systems require accessory items with cables that are typically cumbersome and difficult to direct at a subject.

A need exists for an improved ring flash type for use with close-up photography (macro photography) of a subject. A ring type of flash unit having an annular flash illumination surface is capable of being disposed around the periphery of a lens may be used so that a small subject can be photographed on an enlarged scale in the state of being illuminated with the light emitted from the flash unit.

A need exists for a soft, shadowless light that enables doctors and others to use off the shelf cameras with sufficient lighting, but without concern that the flash units will fall off the camera into the body cavities of the patient.

The problem to be solved by the present embodiments is that higher quality light with more precision is provided in an all-in-one unit without accessory cables.

### SUMMARY OF THE INVENTION

A camera with a light source and a lens with an imaging axis include a flash device, a light transferring device, and a flash dispersion structure. The flash device is located on the housing of the camera and provides light via a flash to a light-transferring device. The light-transferring device directs the light from the flash to the flash dispersion structure. The flash dispersion structure direct the light onto an object of interest, wherein the light is projected around the imaging axis of the lens to produce soft and directed light

The present embodiments are advantageous over the prior are because the ring flash is constructed using a preexisting flash structure for two benefits in one device.

### BRIEF DESCRIPTION OF THE DRAWINGS

In the detailed description of the preferred embodiments presented below, reference is made to the accompanying drawings, in which:

FIG. 1 depicts a perspective view of an embodiment of a camera with a ring flash and a flash unit;

FIG. 2 depicts a perspective view of an embodiment of a camera with a ring flash operated using the flash unit in a hinged down position;

FIG. 3 depicts a perspective view depicting numerous flash units on the camera;

FIG. 4 depicts a side view of an embodiment of a flash unit in a hinged down position to light the flash ring;

FIG. 5 depicts a front view of an embodiment with a flash unit comprised of multiple LEDs;

FIG. 6 depicts a perspective view of the embodiment of a flash unit as a lens attachment; and

FIG. 7 depicts a perspective view of the embodiment of a video camera with a continuous light source flash.

The present embodiments are detailed below with reference to the listed Figures.

### DETAILED DESCRIPTION OF THE INVENTION

Before explaining the present embodiments in detail, it is to be understood that the embodiments are not limited to the particular descriptions and that it can be practiced or carried out in various ways.

The present embodiments create a ring flash by utilizing an existing flash as a light source. A translucent ring at the front of the lens in the location of the bezel directs light from a camera's flash into a chamber near the translucent ring. The light from a camera's flash fills the translucent ring with light the progressively escapes around the lens to form a ring flash.

Many dentists and doctors are using digital cameras, typically bought off the shelf, for use in the medical practice. The present embodiments provide a type of lighting, a ring flash lighting, which the doctors and dentist need in their practice. The embodied device becomes an integral part of the camera and is, therefore, unlikely to fall off into the body cavity during use.

The present embodiments provide a ring flash that creates a very soft shadow or shadow less type lighting that is optimum for most macro photography work, such as dental photography, surgical photography, and close-up nature work.

The embodied ring flash provides soft and precisely directed light that is particularly usable by surgeons and dentists that need to take pictures of very specific body parts. The ring flash provides an even, shadowless light that yields a better overall image, especially for macro photography.

The present embodiments relate to a system when a ring light flash is incorporated onto the lens barrel of a camera, which can be digital or non-digital camera. Alternatively, lights or other LEDs can be used instead of a ring light flash around the barrel lens of the camera. The ring light flash does not have to be continuous and can include a series of lights placed around the barrel of the lens.

The embodied ring flash uses fewer parts than other ring flashes while providing a popup light flash.

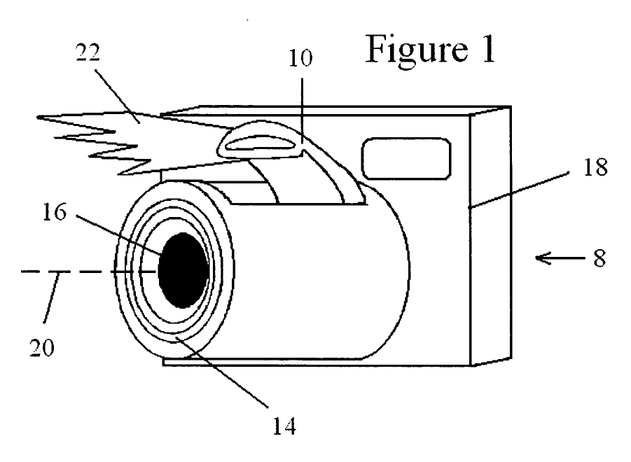

With reference to the figures, FIG. 1 depicts an embodiment of a camera 8 with a light source and a lens 16 with an imaging axis 20. The camera includes a flash device 10, a light transferring device 12, and a flash dispersion structure 14.

The flash device 10 is typically disposed on the housing of the camera 8. An example of a flash device 10 is a cobra flash available from Eastman Kodak. The flash device 10 can be a hinged flash or a moveable pop-up unit. The flash device 10 can be affixed on the housing 18, can be integrated into the housing 18, or can be a removable flash unit. FIG. 1 depicts the embodiment wherein the flash device 10 is integrated into the housing 18 and is in the hinged up position.

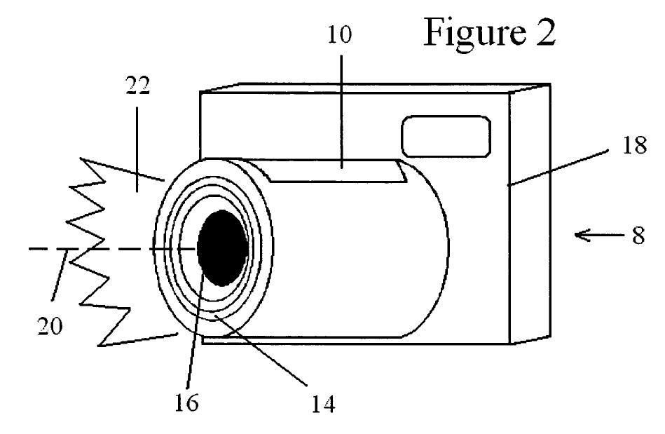

FIG. 2 depicts an embodiment wherein the flash device 10 is in the closed position. The flash device 10 can include a hinge so the angle of the light 22 produced by the flash can be adjusted.

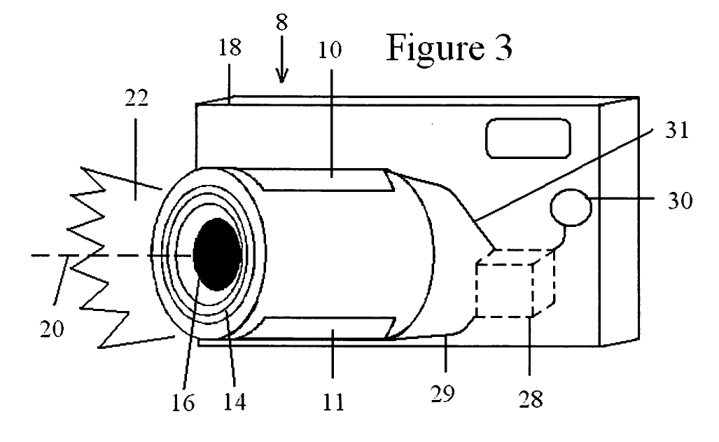

In an alternative embodiment depicted in FIG. 3, the camera 8 can include a second flash device 11 to provide secondary illumination to the flash dispersion structure 14, the ring. If necessary, more than one flash device can be added to the camera.

An electrical circuit 28 with a controller 30 can be used to control the light from the flash devices per a user's preferences. The electrical circuit 28 can typically be connected to the flash devices 10 and 11 via connections, either direct connections or wireless connections. FIG. 3 depicts an embodiment wherein the electrical circuit 28 is connected to the flash devices 10 and 11 via direct connections 29 and 31.

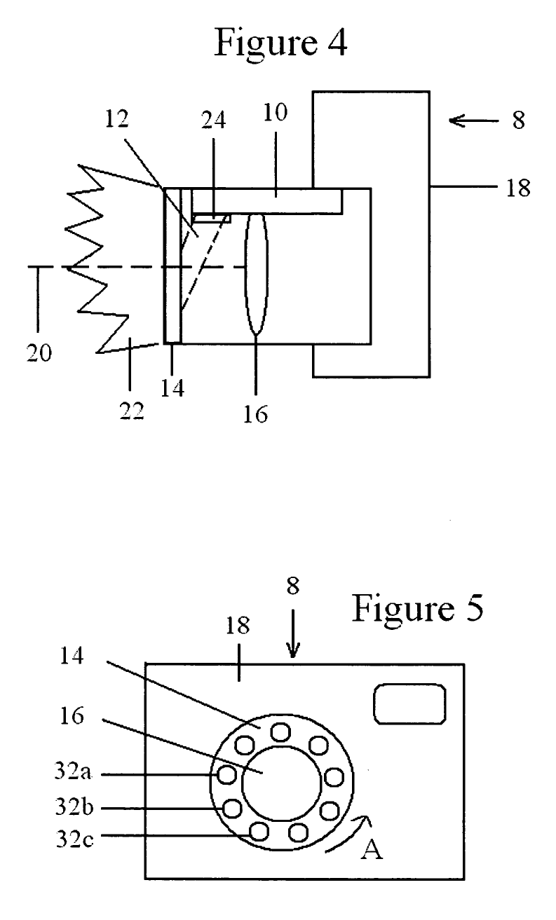

FIG. 4 depicts a side view of an embodiment of the flash device 10 in the hinged down position and in communication the light transferring device 12. The light transferring device 12 transfers the light produced from the flash and directs the light to the flash dispersion structure 14. The light-transferring device 12 can be a reflective surface, a light pipe, a fiber optic cable, or combinations of these items. FIG. 4 depicts an embodiment wherein the light-transferring device 12 is a conduit, such as a light pipe. The light-transferring device 12 can include one or more colored filters to adjust the color or intensity of the light transferred to the flash dispersion structure 14. Preferably, the filter is located within the flash dispersion structure 14 at the flash, at the end of the light-transferring device, or over an external portion of the flash dispersion structure.

Returning to FIG. 1 and FIG. 2, the flash dispersion structure 14 receives light 22 from the light-transferring device 12. The light 22 enters the flash dispersion structure 14 (See FIG. 3) and is projected onto an object of interest around the imaging axis 20 of the lens 16. Preferably, the flash dispersion structure 14 is a ring shaped device disposed around the imaging axis of the camera. The flash dispersion structure 14 can alternatively be an angular tube disposed around the imaging axis of the camera. The tube extends around the circumference of the lens 16.

In an alternative embodiment, the flash dispersion structure 14 can include LEDs 32a, 32b, and 32c that form a light pattern as depicted in FIG. 5. The number of LEDs is only limited by the size of the LEDs and the size of the flash dispersion structure 14 on the camera 8. The LEDs 32a, 32b, and 32c can be white light, colored, or a combination of colors.

In yet another alternative embodiment, the flash dispersion structure 14 can have a ring shape with apertures placed over a complete ring flash to form a light pattern.

In yet another alternative embodiment, the digital flash dispersion structure 14 can be rotatably mounted around the imaging axis of the lens so the user can adjust the lighting for optimum effect. FIG. 5 examples an embodiment wherein the digital flash dispersion structure 14 is rotated in the “A” direction.

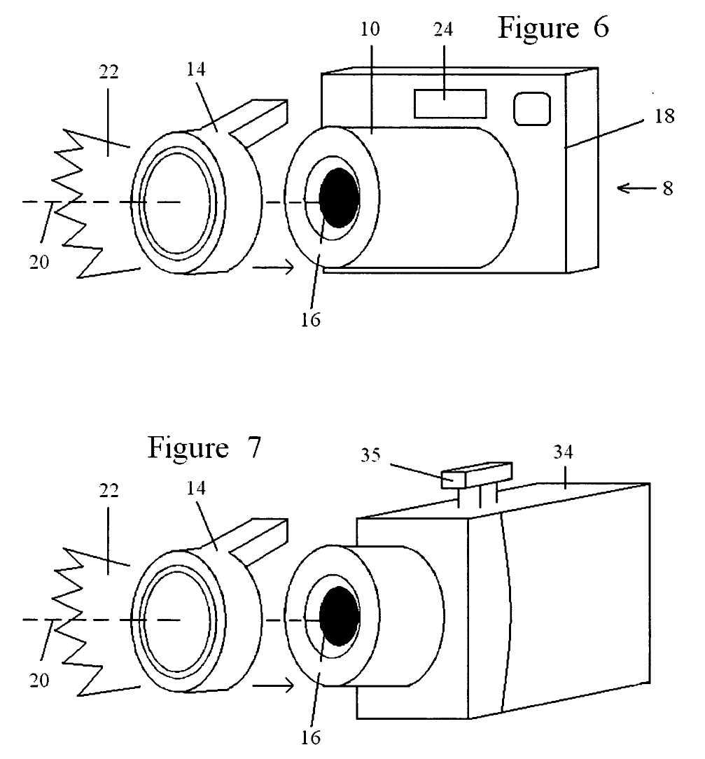

FIG. 6 examples an embodiment using a lens attachment. The flash 24 is built into the housing 18 of the camera 8 and a lens 16. The lens 16 attachment is can have two integrated parts: a flash dispersion structure 14 that slides, threads, or bayonet mounts around the barrel of the lens 16 along the axis 20, and a light transferring device 12. The light-transferring device 12 can be solid, hollow, or flexible and permits light from the flash 24 to transfer to the flash dispersion structure 14. The light 22 is then projected towards the object of interest.

The entire lens attachment device can be solid with clear plastic to transfer the light and can be covered with an opaque material to control the light path and prevent the light from escaping. Alternatively, the flash dispersion structure can be internally mirrored to prevent the light from escaping. The ring can be black as well to prevent the light from escaping. The ring portion of the lens attachment can be solid or can have openings or apertures to allow the controlled distribution of the light. The exterior of the lens attachment device can have a finish or coating that prevents light leakage along the path of light transference pipe.

In another embodiment, the lens attachment can have a coating on the lens to limit the wavelength of light coming from the ring flash. The coating can filter the light leaving the camera and can change the shape of the light from the front of the camera, thereby altering the quantity of light falling on the object of interest.

FIG. 7 shows an embodiment wherein the lens attachment is connected to a video camera 34 with a video camera light source 35. The lens attachment can thread onto the barrel of the video camera lens 16 and can provide the diffused shadowless lighting needed for surgical videography.

The camera, movie camera, or video camera embodiments can utilize a flexible conduit for the light-transferring device, such as a fiber optic or other tube.

The light source can be a steady projecting, constant provision of light. The device can engage, in a “Y” configuration or similar bifurcated configuration, both a light source that is constant from a video camera or external unit and a flash that is instantaneous. The ability to engage both a constant light source and a flash provides the advantage of flexibility and versatility. The embodied attachment can be used to preview an image for composition prior to using a flash.

In an alternative embodiment, the camera can include an electrical circuit that selectively energizes the flash device, the flash dispersion structure, or combinations of both simultaneously.

Embodiments herein are deemed to apply to cameras, digital cameras, video cameras, movie cameras, and other such image recording devices. The embodiments can be used for digital or analog cameras without flashes that simply use steady light sources. The lens attachment can be secured to such a camera to move light from the light source to the ring portion to illuminate the subject. This embodiment is particularly useful when pulsed light is needed, such as strobe effect lighting used for studying objects in motion.

The invention has been described in detail with particular reference to certain preferred embodiments thereof, but it will be understood that variations and modifications can be effected within the spirit and scope of the invention.

### PARTS LIST

8. camera
10. flash device
11. second flash device
12. light transferring device
14. flash dispersion structure
16. lens
18. housing
20. imaging axis
22. light
24. flash integrally mounted to a camera
28. electrical circuit
29. connection
30. controller
31. connection
32a. LED
32b. LED
32c. LED
34. video camera
35. video camera light source

1. A camera with housing and a lens comprising an imaging axis, wherein the camera comprises:
a flash device (10) disposed on a housing (18) of the camera (8);
a light transferring device (12) in communication with the flash device (10) mounted in the housing (18); and
a flash dispersion structure (14) formed around the imaging axis (20) of the lens (16), wherein the flash dispersion structure (14) is adapted to receive light (22) from the light-transferring device (12) and to illuminate an object of interest with light (22).

2. The camera of claim 1, wherein the flash device further comprises a hinge adapted to move and adjust the angle of the flash.

3. The camera of claim 1, wherein the flash device is a removable flash unit.

4. The camera of claim 1, wherein the light transferring device is a reflective surface, a light pipe, a fiber optic, or combinations thereof.

5. The camera of claim 1, wherein the light-transferring device further comprises at least one colored filter disposed within the flash dispersion structure.

6. The camera of claim 5, wherein the filter is near the flash device, near the light transferring device, or over an external portion of the flash dispersion structure.

7. The camera of claim 1, wherein the flash dispersion structure is a ring shaped tube disposed around the imaging axis of the lens and around the circumference of the lens.

8. The camera of claim 1, wherein the flash dispersion structure is an angular tube disposed around the imaging axis of the lens, wherein the angular tube extends around the circumference of the lens.

9. The camera of claim 1, wherein the flash dispersion structure is rotatably mounted around the imaging axis of the lens.

10. The camera of claim 1, wherein the flash dispersion structure further comprises a plurality of LED that form a light pattern around the imaging axis of the lens.

11. The camera of claim 10, wherein at least one LED is colored.

12. The camera of claim 1, wherein the flash dispersion structure comprises a second ring around the imaging axis of the lens with a plurality of apertures for forming a light pattern.

13. The camera of claim 1, further comprising a second flash device adapted to provide secondary flash to the flash dispersion structure.

14. The camera of claim 1, further comprising a light source adapted to provide steady secondary illumination to the flash dispersion structure.

15. The camera of claim 1, wherein the camera is a digital camera, a movie camera, a video camera, or a non-digital camera.

16. A lens attachment for a camera with a built-in flash device to illuminate an object of interest, wherein the lens attachment comprises:
a flash dispersion structure adapted to slide over a lens of the camera; and
a light transferring device acting as a light pipe, wherein the light transferring device comprises a first end and a second end, and wherein the first end is connected to the built-in flash device and on the second end is connected to the flash dispersion structure.

17. The lens attachment of claim 16, wherein the lens attachment is threaded or bayonet mounted to the lens.

18. The lens attachment of claim 16, wherein the light-transferring device is flexible.

19. The lens attachment of claim 16, wherein the camera further comprises a light source, wherein the lens attachment engages both the light source and the built-in flash device.

20. A lens attachment for a video camera with a connected light source to illuminate an object of interest, wherein the lens attachment comprises:
a flash dispersion structure adapted to slide over a lens of a video camera;
a light transferring device acting as a light pipe, wherein the light transferring device comprises a first end and a second, wherein the first end is connected the connected light source and the second end is connected to the flash dispersion structure.

21. The lens attachment of claim 20, wherein the lens attachment is threaded or bayonet mounted to the lens.

22. The lens attachment of claim 20, wherein the light-transferring device is flexible.

23. The lens attachment of claim 20, wherein the video camera additionally has a flash and the lens attachment engages both the light source and the flash.
